(19) United States
(12) Patent Application Publication
(10) Pub. No.: US 2025/0146750 A1
(43) Pub. Date: May 8, 2025

(54) DRYING APPARATUS UTILISING AN INDIRECT INFRARED HEATING SYSTEM

(71) Applicant: SINGNERGY CORPORATION PTE LTD, Singapore (SG)

(72) Inventor: Keng Tai CHUA, Singapore (SG)

(73) Assignee: SINGNERGY CORPORATION PTE LTD, Singapore (SG)

(21) Appl. No.: 18/833,234

(22) PCT Filed: Jan. 25, 2022
(86) PCT No.: PCT/SG2022/050037

§ 371 Date: Jul. 25, 2024

(51) Int. Cl. F26B 17/02; F26B 3/20; F26B 3/30; F26B 5/14

(52) U.S. Cl. CPC F26B 17/023; F26B 5/14; F26B 3/20; F26B 3/30

(57) ABSTRACT

A drying apparatus (1) for drying a substance (2), comprising: a drum (3) rotatable about a central axis, and having an exterior circumferential surface (7) and an interior circumferential surface (5); a belt (9) supported on the drum having a first and second side (15, 17), the belt being adapted to receive the substance on a first side of the belt, and to urge the substance via its first side towards a portion of the exterior circumferential surface of the drum when in operation; wherein one or more infrared heating elements (8) are arranged proximate to and about a portion of the interior circumferential surface of the drum for directing radiant energy to the interior circumferential surface to thereby transfer heat by conduction to the substances being urged between the belt and drum.

### FIELD

The present invention generally relates to drying apparatus for the drying of substances, and in particular to a drying apparatus utilising an indirect Infrared heating system.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

The Applicant markets an apparatus for the drying of substances that uses a combination of heat and compression during the drying process. This is achieved in this drying apparatus by using a heated rotating drum about which is supported a belt. The substance to be dried can be received by the belt which can then urge the substance against the exterior circumferential surface of that drum. The substance can then be subjected to both heating by heat conduction from the heated drum, as well as compression as the substance is compressed between the belt and drum. Thermal oil is currently used as the heat transfer medium within this apparatus.

There are however significant disadvantages associated with the use of thermal oil as a heat transfer medium. Thermal oil as a heat transfer medium is not sustainable and creates the chance of contamination to the surrounding due to thermal oil leakages which is undesirable, especially in food grade environments. Not only do the boilers or heaters occupy a substantial amount of space, but there is also heat loss at the boiler due to the insulated piping between boiler/heater to dryer and flue gas from the boiler leading to less energy efficiency due to heat losses. Additionally, big circulation pumps or blowers are needed for the circulation of heat transfer medium which contributes to huge energy consumption. The working environment when using such heating methods are hot and uncomfortable with the operating temperatures kept relatively low. The additional space required for the external thermal oil boiler along with its auxiliary equipment also makes the insulated piping and boiler commissioning process difficult during site planning and installation.

Furthermore, it takes hours to heat up thermal oil from room temperature to operating temperature before the production can start. It also takes several hours to cool down the system before any maintenance and repair works can be carried out. A significant amount of energy and time are therefore wasted waiting for the target temperature to be achieved to progress to the next step, which is very unproductive.

An object of the invention is to ameliorate one or more of the above-mentioned difficulties associated with the heating medium used for conventional dryers.

### SUMMARY

According to an aspect of the present disclosure, there is provided a drying apparatus for drying a substance, comprising:
a drum rotatable about a central axis, and having an exterior circumferential surface and an interior circumferential surface;
a belt supported on the drum having a first and second side, the belt being adapted to receive the substance on a first side of the belt, and to urge the substance via its first side towards a portion of the exterior circumferential surface of the drum when in operation;
wherein one or more infrared heating elements are arranged proximate to and about a portion of the interior circumferential surface of the drum for directing radiant energy to the interior circumferential surface to thereby transfer heat by conduction to the substances being urged between the belt and drum.

In some embodiments, the drying apparatus further comprises one or more infrared heating elements arranged proximate to and about a portion of the exterior circumferential surface of the drum and directing radiant energy to the belt to thereby transfer heat by conduction to the substance being dried and being urged between the belt and drum.

In some embodiments, the one or more heating elements are in the form of a flat panel.

In some embodiments, the one or more heating elements are in the form of a curved panel.

In some embodiments, the drum has a heating area where heat can be provided to the substance being dried, the heating area having at least one heating zone.

In some embodiments, the heating area has at least one non-heating zone where no heating is provided to the substance being dried.

In some embodiments, the heating area comprises at least two heating zones with heat applied at different temperatures at each said heating zone.

In some embodiments, reflectors are provided on opposing sides of each infrared heating element for reflecting radiant energy towards the drum.

In some embodiments, the belt is porous.

According to another aspect of the present disclosure, there is provided a drying apparatus for drying a substance, comprising:
a drum rotatable about a central axis, and having an exterior circumferential surface and an interior circumferential surface;
a belt supported on the drum having a first and second side, the belt being adapted to receive the substance on a first side of the belt, and to urge the substance via its first side towards a portion of the exterior circumferential surface of the drum when in operation;
wherein one or more infrared heating elements are arranged proximate to and about a portion of the exterior circumferential surface of the drum for directing radiant energy to the belt to thereby transfer heat by conduction to the substance being dried and urged between the belt and drum.

Other aspects and features will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present invention,

FIG. 1 is a schematic side view of an example embodiment of a drying apparatus for drying a substance according to the present disclosure;

FIG. 2 is a schematic side view of the drum and heating element arrangement of another example embodiment of a drying apparatus for drying a substance according to the present disclosure;

FIG. 3 is a schematic side view of the drum and heating element arrangement of a further example embodiment of a drying apparatus for drying a substance according to the present disclosure;

FIGS. 4a and 4b are respective schematic side views of the drum and heating element arrangement of two further example embodiments of a drying apparatus for drying a substance according to the present disclosure;

FIGS. 5a to 5c are respective schematic side views of the drum and heating element arrangement of three additional example embodiments of a drying apparatus for drying a substance according to the present disclosure; and

FIGS. 6a and 6b are respectively a schematic side view of yet another example embodiment of a drying apparatus for drying a substance according to the present disclosure provided with reflectors for the heating elements, and a partial cross-sectional view taken along line A-A of [FIG. 6b].

Other arrangements of the invention are possible and, consequently, the accompanying drawings are not to be understood as superseding the generality of the preceding description of the invention.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

Example embodiments of the present invention will now be described with reference to the accompanying drawings. The terminology used herein is for the purpose of describing particular embodiments only and is not intended to limit the scope of the present invention. Other definitions for selected terms used herein may be found within the detailed description of the invention and apply throughout the description. Additionally, unless defined otherwise, all technical and scientific terms used herein have the same meanings as commonly understood by one or ordinary skill in the art to which this invention belongs. Where possible, the same reference numerals are used throughout the figures for clarity and consistency.

The drying apparatus for drying of a substance according to the present disclosure applies heat and compression to the substance to be dried using a rotating drum and belt carried by the drum in a similar manner to the apparatus as described above. However, the use of a heat transfer medium such as thermal oil is eliminated through the use of infrared heating elements. Typical ‘direct’ infrared dryers have the radiant energy directly focused on the substance. The vapor generated during the drying process will occupy the space in between the infrared heating elements and substance. Thus, ventilated air is usually required to carry away the vapor in such typical cases, resulting in some radiant energy being wasted to the unnecessary heating of ventilated air and vapor.

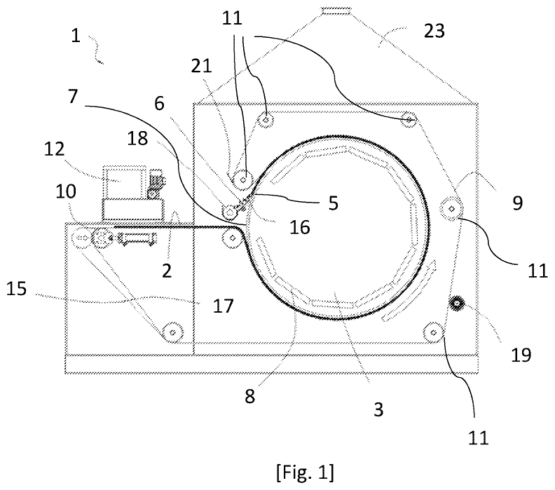

The drying apparatus according to the present disclosure however uses an ‘indirect’ infrared heating of the substance where one or more infrared heating elements are used to heat the drum and/or belt using radiant energy so that the substance is indirectly heated through heat conduction from the drum and/or belt. The belt may preferably be porous to thereby allow water within the substance to evaporate and escape through the porous belt.

[FIG. 1] shows an example embodiment of a drying apparatus for drying substances according to the present disclosure. The drying apparatus 1 comprises a generally cylindrical rotating drum 3 rotatable about a central axis and having an interior circumferential surface 5, and an exterior circumferential surface 7. A continuous belt 9 having a first side 15 and second side 17 is supported for travel through the drying apparatus, the belt 9 being supported by a series of rollers 11 and by the drum 3. A belt take-up roller 10 is used to press against the belt second side 17 to thereby apply tension to the belt 9 so that the belt first side 15 will be urged against the drum exterior circumferential surface 7 as it moves though the drying apparatus 1. A feeder device 12 is used to feed a wet substance 2 onto the belt first side 15. This wet substance 2 then travels with the belt 9 and is pressed against the drum exterior circumferential surface 7. The drum 3 and belt 9 may be made of either a metal or non-metal material. By comparison, drying apparatus that use thermal oil as a heat transfer medium will typically require that the drum be made from metal.

One or more infrared heating elements 8 may be used in the drying apparatus 1 according to the present disclosure. The embodiment shown in [FIG. 1] utilises a series of infrared heating elements 8 located in a closely adjacent relationship to the drum interior circumferential surface 5 in the drying apparatus embodiment shown in [FIG. 1]. Each infrared heating element 8 can be powered by electricity or by gases such as natural gas, propane gas, biogas, synthetic gas or hydrogen in the absence of flame. The infrared heating element 8 generates concentrated radiant energy which is very focused and can be directed in the same manner as light, towards a specific area of the drum interior circumferential surface 5. The drum 3 intercepts and absorbs the radiant energy, converting that energy into heat, without an intervening heat transfer medium such as air and/or liquid between the drum and infrared heating element 8. Therefore, energy losses are reduced by removing the need to heat a heat transfer medium and/or surroundings. The heat is then applied by heat conduction through the wall of the drum 3 to the wet substance 2 as it is urged against the drum exterior circumferential surface 7. The wet substance 2 is therefore dried using both heat and compression within the apparatus. The drying apparatus 1 therefore utilises an ‘indirect’ infrared system because the infrared heating elements 8 do not directly focus their radiant energy on the wet substance 2 as is the case in conventional infrared dryers. The water evaporated from the wet substance 2 as it is being dried is carried away from the drying apparatus 1 via a hood 23 provided above the drum 3. The belt 9 may be porous to allow the evaporated water to escape through the porous belt 9. The final dried product 6 is then scrapped off the belt 9 by a belt scrapper 21, and drops onto an output conveyer 18 to be discharged from the drying apparatus. A drum scrapper 16 is also used to remove any remaining dried product 6 from the drum exterior circumferential surface 7 which can also drop onto the output conveyer 18. A belt cleaning bush 19 is then used to clean the belt 9 by brushing off any remaining dried product 6 from the belt first side.

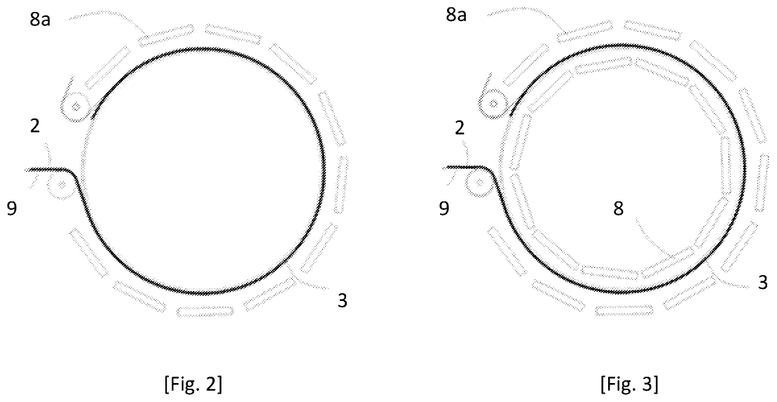

The embodiment of the drying apparatus 1 shown in [FIG. 1] has the infrared heating elements 8 located within the drum 3 closely adjacent the drum interior circumferential surface 5. In another embodiment of the drying apparatus according to the present disclosure, infrared heating elements 8a can be located outside of the drum 3 and closely adjacent to the belt 9 when the belt 9 is supported on the drum 3 as shown in [FIG. 2]. In this arrangement, some of the radiant energy is absorbed by the belt 9 and some of the radiant energy is transmitted through the belt 9 and absorbed by the wet substance 2 directly. Part of the radiant energy absorbed by the belt 9 will be converted into heat and transferred to the wet substance 2 by heat conduction. Part of the radiant energy will be transmitted through the belt 9 and directly absorbed by the wet substance 2 and converted into heat to evaporate the water within.

[FIG. 3] shows a further embodiment of the drying apparatus according to the present disclosure where a series of heating elements 8,8a are respectively located within the drum 3 and closely adjacent to the drum interior circumferential surface 7, and outside of the drum 3 and closely adjacent to the belt 9 when supported on the drum 3. With this arrangement, the wet substance 2 receives heat from both the drum 3 and belt 9 as well as by direct absorption of the radiant energy, thus allowing a thicker layer of wet substances 2 to be fed onto the belt 9 thereby and increasing the dryer's capacity or throughput.

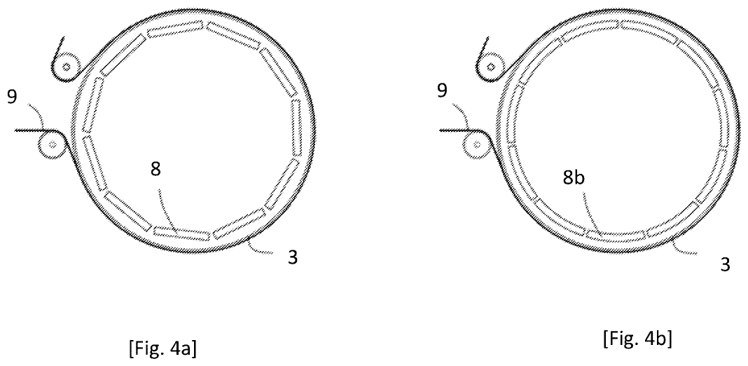

The embodiments of the drying apparatus 1 previously shown in [FIGS. 1 to 3] and also in the embodiment shown in [FIG. 4a] show the infrared heating elements 8,8a in the form of flat panels. It is however also envisaged that infrared heating elements 8b in the form of curved panels be used depending on the extent of customization to the drum curvature. The objective is to maintain a consistent and shortest possible gap between the surface of the curved infrared heating element 8b and the drum interior circumferential surface 5. This aims to increase the heat transfer efficiency and improve the heat distribution as much as possible.

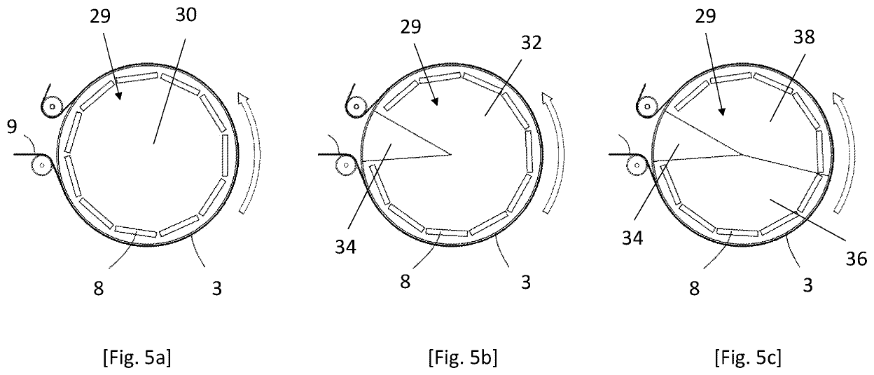

The drum 3 may have a heating area 29 where heat can be provided to the wet substance 2 being dried. The heating area 29 may comprise a single heating zone 30 as shown in [FIG. 5a] where heat is applied at a uniform temperature within the entire heating area 29 of the drum 3. Improvements can however be obtained in the dried final product 6, and/or the heating duration of the wet substance 2 can be reduced if the heating area 29 of the drum 3 is divided into more than one zone. [FIG. 5b] shows an arrangement where the heating area is divided into a heating zone 32, and a smaller non-heating zone 34 where no heat is being applied. [FIG. 5c] shows an arrangement where the heating area 29 is divided into two heating zones 36, 38 of similar area, and a smaller non-heating zone 34. One heating zone 36 may have a higher operating temperature to accelerate the water evaporation from the wet substance 2. The water content of the wet substance 2 would then be potentially reduced, and the wet substance temperature would have been elevated prior to entering the second heating zone 38, which will have a lower operating temperature, to continue the heating process. This will ensure better dried product quality while reducing overall energy consumption and increasing throughput.

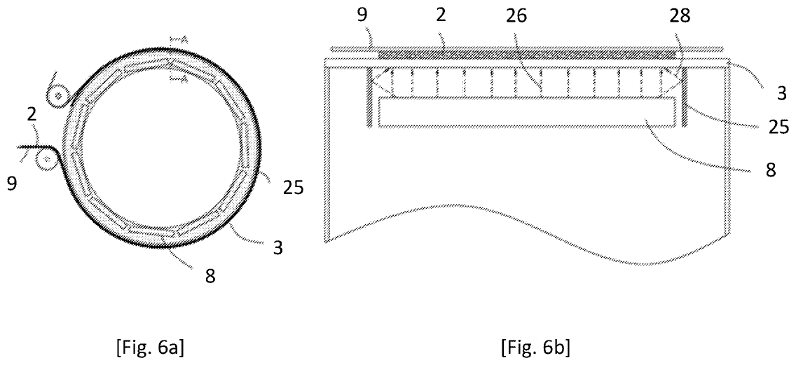

In a further example embodiment of the drying apparatus 1 according to the present disclosure as shown in [FIGS. 6a and 6b], two reflectors 25 made of polished metal and generally annular in shape are installed at both sides of the infrared heating elements 8 providing direct radiant energy 26 to the drum 3, the reflectors 25 helping to redirect edge loss radiant energy 28 back onto the drum 3. This can help to increase the energy efficiency as well as keeping the drum's side walls and surrounding area cool. Similar reflectors could also be used with infrared heating elements position outside of the drum 3 for redirecting edge loss radiant energy back onto the belt 9.

The drying apparatus according to the present disclosure can be used in the food/food ingredient industries for human consumption or animal feeds which have processes requiring dried products which retains nutritional value, organoleptic properties, and calorific values, such as:

### Fish Processing

Fish processing facilities can look to convert fish trimmings into wholesome, aromatic and nutritious components of food ingredients/recipes to boost nourishment and taste to upcycle the trimmings into profitable consumer products.

The aquaculture industry in fish/shrimp feed production has been gradually moving away from wild feed for some time and have identified the need to manufacture fish feed with high nutrition while raising productivity, strengthen climate resilience and overcome resource constraints.

Dried fish trimmings are also an extremely attractive ingredient to be incorporated in pet foods to boost aroma, flavor and most importantly, nutrition.

### Agriculture

Dried fruit and vegetable products are gaining popularity as more people are turning their focus to healthier snacks/food ingredients. The cost of dried fruit or vegetable are expensive mainly due to the high cost of production. The challenge lies in the retention of taste, flavor, color as well as texture during the production and the available technologies which are able to achieve these criteria. Fruit and vegetable powder can be used in beverages, cooking as well as garnishing.

Plant based food processing plants may dry ugly and unwanted fruit/vegetables or even dry fresh produce. Specific temperature control will be able to retain a large proportion of the desirable nutrients in dried form and be used as food ingredients or animal/aqua feed.

Pet owners are also willing to buy premium dried fruit and vegetable products for their animals in hopes of incorporating superior nutrition into their pet's diets.

### Meat Processing

Food processing operations such as meat, poultry or seafood processing plants produce large amounts of organic side streams that are rich in nutrients. The invention will convert these side streams into products containing high levels of protein and minerals.

The use of infrared heating elements in place of thermal oil as a heat source lowers the carbon footprint while creating a more energy efficient drying method, and improving productivity. The use of an infrared heating system in place of thermal oil also eliminates the need of external boilers, insulated piping and other ancillary equipment associated with thermal oil leading to space savings. An installed drying apparatus according to the present disclosure can therefore occupy significantly less space. The low thermal inertia of the infrared radiation heating enables fast pre-heating time, it typically takes less than ten minutes to reach operating temperature. By comparison, it can take hours to heat up thermal oil from room temperature to operating temperature before the production can start. It also takes several hours to cool down the system before maintenance and repair works can be carried out. A significant amount of energy and time are therefore wasted waiting for the target temperature to be achieved to progress to the next step, and that is very unproductive. Many places or countries prefer the use of fuel gas (LNG, LPG) as it has a much lower unit cost compared to electricity. The use of infrared heating elements can therefore lead to lower operating costs. The cost saving will be substantial especially in large volume drying applications. Furthermore, as the infrared heating elements can preferably be located within the drum to heat the interior circumferential surface in a focused and direct manner, energy lost to heating the air or surroundings will be minimised.

The use of the new indirect heating method in the drying apparatus according to the present disclosure can also allow for a more efficient waste to energy development to be made possible, as synthetic gas generated during the gasification process can be supplied directly to the infrared heating elements. This is in contrast with dryers which require thermal oil as a heat transfer medium. With the new indirect heating method according to the present disclosure, it will be able to eliminate the need to use synthetic gas to heat up the thermal oil within an external boiler before the hot thermal oil is circulated to the heating drum.

Unless defined otherwise, all technical and scientific terms used herein have the same meaning as is commonly understood by a skilled person to which the subject matter herein belongs.

It should be appreciated by the person skilled in the art that the above invention is not limited to the embodiment described. It is appreciable that modifications and improvements may be made without departing from the scope of the present invention.

It should be further appreciated by the person skilled in the art that one or more of the above modifications or improvements, not being mutually exclusive, may be further combined to form yet further embodiments of the present invention.

1. A drying apparatus for drying a substance, comprising:
a drum rotatable about a central axis, and having an exterior circumferential surface and an interior circumferential surface;
a belt supported on the drum having a first and second side, the belt being adapted to receive the substance on a first side of the belt, and to urge the substance via its first side towards a portion of the exterior circumferential surface of the drum when in operation;
wherein one or more infrared heating elements are arranged proximate to and about a portion of the interior circumferential surface of the drum for directing radiant energy to the interior circumferential surface to thereby transfer heat by conduction to the substances being urged between the belt and drum.

2. A drying apparatus according to claim 1, further comprising one or more infrared heating elements arranged proximate to and about a portion of the exterior circumferential surface of the drum and directing radiant energy to the belt to thereby transfer heat by conduction to the substances being urged between the belt and drum.

3. A drying apparatus according to claim 1 or 2, wherein the one or more heating elements are in the form of a flat panel.

4. A drying apparatus according to claim 1 or 2, wherein the one or more heating elements are in the form of a curved panel.

5. A drying apparatus according to any one of the preceding claims, wherein the drum has a heating area where heat can be provided to the substance being dried, the heating area having at least one heating zone.

6. A drying apparatus according to claim 5, wherein the heating area has at least one non-heating zone where no heat is provided to the substance being dried.

7. A drying apparatus according to claim 5 or 6, wherein the heating area comprises at least two heating zones with heating applied at different temperatures at each said heating zone.

8. A drying apparatus according to any one of the preceding claims, wherein reflectors are provided on opposing sides of each infrared heating element for reflecting radiant energy towards the drum.

9. A drying apparatus according to any one of the preceding claims wherein the belt is porous.

10. A drying apparatus for drying a substance, comprising:
a drum rotatable about a central axis, and having an outer circumferential surface and an interior circumferential surface;
a belt supported on the drum having a first and second side, the belt being adapted to receive the substance on a first side of the belt, and to urge the substance via its first side towards a portion of the exterior circumferential surface of the drum when in operation;
wherein one or more infrared heating elements are arranged proximate to and about a portion of the exterior circumferential surface of the drum for directing radiant energy to the belt to thereby transfer heat by conduction to the substance being dried and urged between the belt and drum.

11. A drying apparatus according to claim 10, wherein the one or more heating elements are in the form of a flat panel.

12. A drying apparatus according to claim 10, wherein the one or more heating elements are in the form of a curved panel.

13. A drying apparatus according to any one of claims 10 to 12, wherein the drum has a heating area where heat can be provided to the substance being dried, the heating area having at least one heating zone.

14. A drying apparatus according to claim 13, wherein the heating area has at least one non-heating zone where no heat is provided to the substance being dried.

15. A drying apparatus according to claim 13 or 14, wherein the heating area comprises at least two heating zones with heating applied at different temperatures at each said heating zone.

16. A drying apparatus according to any one of claims 10 to 15, wherein reflectors are provided on opposing sides of each infrared heating element for reflecting radiant energy towards the drum.

17. A drying apparatus according to any one of claims 10 to 16, wherein the belt is porous.
